(19) United States
(12) Patent Application Publication
(10) Pub. No.: US 2021/0250717 A1
(43) Pub. Date: Aug. 12, 2021

(54) Spatial audio Capture, Transmission and Reproduction

(71) Applicant: Nokia Technologies Oy, Espoo (FI)

(72) Inventors: Mikko-Ville LAITINEN, Espoo (FI); Milkka VILERMO, Siuro (FI); Mikko TAMMI, Tampere (FI); Jussi VIROLAINEN, Espoo (FI); Juha VILKAMO, Helsinki (FI)

(21) Appl. No.: 16/973,600

(22) PCT Filed: Jun. 12, 2019
(86) PCT No.: PCT/FI2019/050453

§ 371 Date: Dec. 9, 2020

(30) Foreign Application Priority Data
Jun. 15, 2018 (GB) 1809851.7

(51) Int. Cl. H04S 1/00; H04S 7/00

(52) U.S. Cl. CPC H04S 1/002; H04S 2400/01; H04S 2400/07; H04S 7/307

(57) ABSTRACT

An apparatus including circuitry configured for: receiving at least two audio signals; determining at least one lower frequency effect parameter based on the at least two audio signals; determining at least one transport audio signal based on the at least two audio signals; controlling a transmission/storage of the at least one transport audio signal and the at least one lower frequency effect information such that a rendering based on the at least one transport audio signal and the at least one lower frequency effect information enables a determination of at least one low frequency effect channel.

### FIELD

The present application relates to apparatus and methods for spatial sound capturing, transmission, and reproduction, but not exclusively for spatial sound capturing, transmission, and reproduction within an audio encoder and decoder.

### BACKGROUND

Typical loudspeaker layouts for multichannel reproduction (such as 5.1) include “normal” loudspeaker channels and low frequency effect (LFE) channels. The normal loudspeaker channels (i.e., the 5. part) contain wideband signals. Using these channels an audio engineer can for example position an auditory object to a desired direction. The LFE channels (i.e., the .1 part) contain only low-frequency signals (<120 Hz), and it are typically reproduced with a subwoofer. LFE was originally developed for reproducing separate low-frequency effects, but has also been used for routing part of the low-frequency energy of a sound field to a subwoofer.

All common multichannel loudspeaker layouts, such as 5.1, 7.1, 7.1+4, and 22.2, contain at least one LFE channel. Hence, it is desirable for any spatial-audio processing system with loudspeaker reproduction to utilize the LFE channel.

If the input to the system is a multichannel mix (e.g., 5.1), and the output is to multichannel loudspeaker setup (e.g., 5.1), the LFE channel does not need any specific processing, it can be directly routed to the output. However, the multichannel signals may be transmitted, and typically the audio signals require compression in order to have a reasonable bit rate.

Parametric spatial audio processing is a field of audio signal processing where the spatial aspect of the sound is described using a set of parameters. For example, in parametric spatial audio capture from microphone arrays, it is a typical and an effective choice to estimate from the microphone array signals a set of parameters such as directions of the sound in frequency bands, and the ratios between the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

### SUMMARY

There is provided according to a first aspect an apparatus comprising means for: receiving at least two audio signals; determining at least one lower frequency effect information based on the at least two audio signals; determining at least one transport audio signal based on the at least two audio signals; controlling a transmission/storage of the at least one transport audio signal and the at least one lower frequency effect information such that a rendering based on the at least one transport audio signal and the at least one lower frequency effect information enables a determination of at least one low frequency effect channel.

The apparatus may further comprise means for: determining at least one spatial metadata parameter based on the at least two audio signals, and wherein the means for controlling the transmission/storage of the at least one transport audio signal and the at least one lower frequency effect information may be further for controlling a transmission/storage of the at least one spatial metadata parameter.

The at least one spatial metadata parameter may comprise at least one of: at least one direction parameter associated with at least one frequency band of the at least two audio signals; and at least one direct-to-total energy ratio associated with the at least one frequency band of the at least two audio signals.

The means for determining the at least one transport audio signal based on the at least two audio signals may comprise at least one of: a downmix of the at least two audio signals; a selection of the at least two audio signals; an audio processing of the at least two audio signals; and an ambisonic audio processing of the at least two audio signals.

The at least two audio signals may be at least one of: multichannel loudspeaker audio signals; ambisonic audio signals; and microphone array audio signals.

The at least two audio signals may be multichannel loudspeaker audio signals and wherein the means for determining the at least one lower frequency effect information based on the at least two audio signals may be for determining at least one low frequency effect to total energy ratio based on a computation of at least one ratio between energy of at least one defined low frequency effect channel of the multichannel loudspeaker audio signals and a selected frequency range of all channels of the multichannel loudspeaker audio signals.

The at least two audio signals may be microphone array audio signals or ambisonic audio signals and wherein the means for determining the at least one lower frequency effect information based on the at least two audio signals may be for determining at least one low frequency effect to total energy ratio based on based on a time filtered direct-to-total energy ratio value.

The at least two audio signals may be microphone array audio signals or ambisonic audio signals and wherein the means for determining the at least one lower frequency effect information based on the at least two audio signals may be for determining at least one low frequency effect to total ratio based on an energy weighted time filtered direct-to-total energy ratio value.

The means for determining the at least one lower frequency effect information based on the at least two audio signals may be for determining the at least one lower frequency effect information based on the at least one transport audio signal.

The lower frequency effect information may comprise at least one of: at least one low frequency effect channel energy ratio; at least one low frequency effect channel energy; and at least one low frequency effect to total energy ratio.

According to a second aspect there is provided an apparatus comprising means for: receiving at least one transport audio signal and at least one lower frequency effect information; and rendering at least one low frequency effect channel based on the at least one transport audio signal and the at least one lower frequency effect information.

The apparatus may further comprise means for: generating at least one low frequency effect part based on a filtered part of the at least one transport audio signal and the at least one lower frequency effect information; and generating the least one low frequency effect channel based on the at least one low frequency effect part.

The apparatus may further comprise means for generating the filtered part of the at least one transport audio signal by applying a filterbank to the at least one transport audio signal.

The apparatus may further comprise means for: receiving at least one at least one spatial metadata parameter; and generating at least two audio signals based on the at least one transport audio signal and the at least one spatial metadata parameter.

The lower frequency effect information may comprise at least one of: at least one low frequency effect channel energy ratio; at least one low frequency effect channel energy; and at least one low frequency effect to total energy ratio.

According to a third aspect there is provided a method comprising: receiving at least two audio signals; determining at least one lower frequency effect information based on the at least two audio signals; determining at least one transport audio signal based on the at least two audio signals; controlling a transmission/storage of the at least one transport audio signal and the at least one lower frequency effect information such that a rendering based on the at least one transport audio signal and the at least one lower frequency effect information enables a determination of at least one low frequency effect channel.

The method may further comprise: determining at least one spatial metadata parameter based on the at least two audio signals, and wherein controlling the transmission/storage of the at least one transport audio signal and the at least one lower frequency effect information may be further for controlling a transmission/storage of the at least one spatial metadata parameter.

The at least one spatial metadata parameter may comprise at least one of: at least one direction parameter associated with at least one frequency band of the at least two audio signals; and at least one direct-to-total energy ratio associated with the at least one frequency band of the at least two audio signals.

Determining the at least one transport audio signal based on the at least two audio signals may comprise at least one of: a downmix of the at least two audio signals; a selection of the at least two audio signals; an audio processing of the at least two audio signals; and an ambisonic audio processing of the at least two audio signals.

The at least two audio signals may be at least one of: multichannel loudspeaker audio signals; ambisonic audio signals; and microphone array audio signals.

The at least two audio signals may be multichannel loudspeaker audio signals and wherein determining the at least one lower frequency effect information based on the at least two audio signals may comprise determining at least one low frequency effect to total energy ratio based on a computation of at least one ratio between energy of at least one defined low frequency effect channel of the multichannel loudspeaker audio signals and a selected frequency range of all channels of the multichannel loudspeaker audio signals.

The at least two audio signals may be microphone array audio signals or ambisonic audio signals and wherein determining the at least one lower frequency effect information based on the at least two audio signals may comprise determining at least one low frequency effect to total energy ratio based on based on a time filtered direct-to-total energy ratio value.

The at least two audio signals may be microphone array audio signals or ambisonic audio signals and wherein determining the at least one lower frequency effect information based on the at least two audio signals may comprise determining at least one low frequency effect to total ratio based on an energy weighted time filtered direct-to-total energy ratio value.

Determining the at least one lower frequency effect information based on the at least two audio signals may comprise determining the at least one lower frequency effect information based on the at least one transport audio signal.

The lower frequency effect information may comprise at least one of: at least one low frequency effect channel energy ratio; at least one low frequency effect channel energy; and at least one low frequency effect to total energy ratio.

According to a fourth aspect there is provided a method comprising: receiving at least one transport audio signal and at least one lower frequency effect information; and rendering at least one low frequency effect channel based on the at least one transport audio signal and the at least one lower frequency effect information.

Rendering the at least one low frequency effect channel based on the at least one transport audio signal and at least one lower frequency effect information may comprise: generating at least one low frequency effect part based on a filtered part of the at least one transport audio signal and the at least one lower frequency effect information; and generating the least one low frequency effect channel based on the at least one low frequency effect part.

Generating the filtered part of the at least one transport audio signal may comprise applying a filterbank to the at least one transport audio signal.

The method may further comprise: receiving at least one at least one spatial metadata parameter; and generating at least two audio signals based on the at least one transport audio signal and the at least one spatial metadata parameter.

The lower frequency effect information may comprise at least one of: at least one low frequency effect channel energy ratio; at least one low frequency effect channel energy; and at least one low frequency effect to total energy ratio.

According to a fifth aspect there is provided an apparatus comprising at least one processor and at least one memory including a computer program code, the at least one memory and the computer program code configured to, with the at least one processor, cause the apparatus to: receive at least two audio signals; determine at least one lower frequency effect information based on the at least two audio signals; determine at least one transport audio signal based on the at least two audio signals; control a transmission/storage of the at least one transport audio signal and the at least one lower frequency effect information such that a rendering based on the at least one transport audio signal and the at least one lower frequency effect information enables a determination of at least one low frequency effect channel.

The apparatus may be further caused to: determine the at least one spatial metadata parameter based on the at least two audio signals, and wherein the apparatus caused to control a transmission/storage of the at least one transport audio signal and the at least one lower frequency effect information may be further caused to control a transmission/storage of the at least one spatial metadata parameter.

The at least one spatial metadata parameter may comprise at least one of: at least one direction parameter associated with at least one frequency band of the at least two audio signals; and at least one direct-to-total energy ratio associated with the at least one frequency band of the at least two audio signals.

The apparatus caused to determine the at least one transport audio signal based on the at least two audio signals may be caused to perform at least one of: a downmix of the at least two audio signals; a selection of the at least two audio signals; an audio processing of the at least two audio signals; and an ambisonic audio processing of the at least two audio signals.

The at least two audio signals may be at least one of: multichannel loudspeaker audio signals; ambisonic audio signals; and microphone array audio signals.

The at least two audio signals may be multichannel loudspeaker audio signals and wherein the apparatus caused to determine the at least one lower frequency effect information based on the at least two audio signals may be caused to determine at least one low frequency effect to total energy ratio based on a computation of at least one ratio between energy of at least one defined low frequency effect channel of the multichannel loudspeaker audio signals and a selected frequency range of all channels of the multichannel loudspeaker audio signals.

The at least two audio signals may be microphone array audio signals or ambisonic audio signals and wherein the apparatus caused to determine the at least one lower frequency effect information based on the at least two audio signals may be caused to determine at least one low frequency effect to total energy ratio based on based on a time filtered direct-to-total energy ratio value.

The at least two audio signals may be microphone array audio signals or ambisonic audio signals and wherein the apparatus caused to determine the at least one lower frequency effect information based on the at least two audio signals may be caused to determine at least one low frequency effect to total ratio based on an energy weighted time filtered direct-to-total energy ratio value.

The apparatus caused to determine at least one lower frequency effect information based on the at least two audio signals may be caused to determine the at least one lower frequency effect information based on the at least one transport audio signal based.

The lower frequency effect information may comprise at least one of: at least one low frequency effect channel energy ratio; at least one low frequency effect channel energy; and at least one low frequency effect to total energy ratio.

According to a sixth aspect there is provided an apparatus comprising at least one processor and at least one memory including a computer program code, the at least one memory and the computer program code configured to, with the at least one processor, cause the apparatus at least to: receive at least one transport audio signal and at least one lower frequency effect information; and render at least one low frequency effect channel based on the at least one transport audio signal and the at least one lower frequency effect information.

The apparatus caused to render at least one low frequency effect channel based on the at least one transport audio signal and the at least one lower frequency effect information may be caused to: generate at least one low frequency effect part based on a filtered part of the at least one transport audio signal and the at least one lower frequency effect information; and generate the least one low frequency effect channel based on the at least one low frequency effect part.

The apparatus caused to generate the filtered part of the at least one transport audio signal may be caused to apply a filterbank to the at least one transport audio signal.

The apparatus may further be caused to: receive at least one at least one spatial metadata parameter; and generate at least two audio signals based on the at least one transport audio signal and the at least one spatial metadata parameter.

The lower frequency effect information may comprise at least one of: at least one low frequency effect channel energy ratio; at least one low frequency effect channel energy; and at least one low frequency effect to total energy ratio.

According to a seventh aspect there is provided an apparatus comprising: means for receiving at least two audio signals; determining at least one lower frequency effect information based on the at least two audio signals; means for determining at least one transport audio signal based on the at least two audio signals; means for controlling a transmission/storage of the at least one transport audio signal and the at least one lower frequency effect information such that a rendering based on the at least one transport audio signal and the at least one lower frequency effect information enables a determination of at least one low frequency effect channel.

According to an eighth aspect there is provided an apparatus comprising: means for receiving at least one transport audio signal and at least one lower frequency effect information; and means for rendering at least one low frequency effect channel based on the at least one transport audio signal and the at least one lower frequency effect information.

According to a ninth aspect there is provided a computer program comprising instructions [or a computer readable medium comprising program instructions] for causing an apparatus to perform at least the following: determining at least one transport audio signal based on at least two audio signals; controlling a transmission/storage of the at least one transport audio signal and at least one lower frequency effect information such that a rendering based on the at least one transport audio signal and the at least one lower frequency effect information enables a determination of at least one low frequency effect channel.

According to a tenth aspect there is provided a computer program comprising instructions [or a computer readable medium comprising program instructions] for causing an apparatus to perform at least the following: receiving at least one transport audio signal and at least one lower frequency effect information; and rendering at least one low frequency effect channel based on the at least one transport audio signal and the at least one lower frequency effect information.

According to an eleventh aspect there is provided a non-transitory computer readable medium comprising program instructions for causing an apparatus to perform at least the following: determining at least one transport audio signal based on at least two audio signals; controlling a transmission/storage of the at least one transport audio signal and at least one lower frequency effect information such that a rendering based on the at least one transport audio signal and the at least one lower frequency effect information enables a determination of at least one low frequency effect channel.

According to a twelfth aspect there is provided a non-transitory computer readable medium comprising program instructions for causing an apparatus to perform at least the following: receiving at least one transport audio signal and at least one lower frequency effect information; and rendering at least one low frequency effect channel based on the at least one transport audio signal and the at least one lower frequency effect information.

According to a thirteenth aspect there is provided an apparatus comprising: determining circuitry configured to: determine at least one transport audio signal based on at least two audio signals; controlling circuitry configured to control a transmission/storage of the at least one transport audio signal and at least one lower frequency effect information such that a rendering based on the at least one transport audio signal and the at least one lower frequency effect information enables a determination of at least one low frequency effect channel.

According to a fourteenth aspect there is provided an apparatus comprising: receiving circuitry configured to receive at least one transport audio signal and at least one lower frequency effect information; and rendering circuitry configured to render at least one low frequency effect channel based on the at least one transport audio signal and the at least one lower frequency effect information.

According to a fifteenth aspect there is provided a computer readable medium comprising program instructions for causing an apparatus to perform at least the following: determining at least one transport audio signal based on at least two audio signals; controlling a transmission/storage of the at least one transport audio signal and at least one lower frequency effect information such that a rendering based on the at least one transport audio signal and the at least one lower frequency effect information enables a determination of at least one low frequency effect channel.

According to a sixteenth aspect there is provided a computer readable medium comprising program instructions for causing an apparatus to perform at least the following: receiving at least one transport audio signal and at least one lower frequency effect information; and rendering at least one low frequency effect channel based on the at least one transport audio signal and the at least one lower frequency effect information.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows a flow diagram of the operation of the system as shown in FIG. 1 according to some embodiments;

FIG. 3 shows schematically capture/encoding apparatus suitable for implementing some embodiments;

FIG. 4 shows schematically low frequency effect channel analyser apparatus as shown in FIG. 3 suitable for implementing some embodiments;

FIG. 5 shows a flow diagram of the operation of low frequency effect channel analyser apparatus according to some embodiments;

FIG. 6 shows schematically rendering apparatus suitable for implementing some embodiments;

FIG. 7 shows a flow diagram of the operation of the rendering apparatus shown in FIG. 6 according to some embodiments;

FIG. 8 shows schematically further rendering apparatus suitable for implementing some embodiments;

FIG. 9 shows a flow diagram of the operation of the further rendering apparatus shown in FIG. 8 according to some embodiments;

FIG. 10 shows schematically further capture/encoding apparatus suitable for implementing some embodiments;

FIG. 11 shows schematically further low frequency effect channel analyser apparatus as shown in FIG. 10 suitable for implementing some embodiments;

FIG. 12 shows a flow diagram of the operation of the further low frequency effect channel analyser apparatus shown in FIG. 11 according to some embodiments;

FIG. 13 shows schematically ambisonic input encoding apparatus suitable for implementing some embodiments;

FIG. 14 shows schematically the low frequency effect channel analyser apparatus as shown in FIG. 13 suitable for implementing some embodiments;

FIG. 15 shows a flow diagram of the operation of the low frequency effect channel analyser apparatus shown in FIG. 14 according to some embodiments;

FIG. 16 shows schematically multichannel loudspeaker input encoding apparatus suitable for implementing some embodiments;

FIG. 17 shows schematically rendering apparatus for receiving the output of the multichannel loudspeaker input encoding apparatus as shown in FIG. 16 according to some embodiments;

FIG. 18 shows a flow diagram of the operation of the rendering apparatus shown in FIG. 17 according to some embodiments; and

FIG. 19 shows schematically shows schematically an example device suitable for implementing the apparatus shown.

### EMBODIMENTS OF THE APPLICATION

The following describes in further detail suitable apparatus and possible mechanisms for the provision of effective spatial analysis derived metadata parameters for microphone array and other input format audio signals.

Apparatus have been designed to transmit a spatial audio modelling of a sound field using N (which is typically 2) transport audio signals and spatial metadata. The transport audio signals are typically compressed with a suitable audio encoding scheme (for example advanced audio coding—AAC or enhanced voice services—EVS codecs). The spatial metadata may contain parameters such as Direction (for example azimuth, elevation) in time-frequency domain, and Direct-to-total energy ratio (or energy or ratio parameters) in time-frequency domain.

This kind of parametrization may be denoted as sound-field related parametrization in the following disclosure. Using the direction and the direct-to-total energy ratio may be denoted as direction-ratio parameterization in the following disclosure. Further parameters may be used instead/in addition to these (e.g., diffuseness instead of direct-to-total-energy ratio, and adding a distance parameter to the direction parameter). Using such sound-field related parametrization, a spatial perception similar to that which would occur in the original sound field may be reproduced. As a result, the listener can perceive the multitude of sources, their directions and distances, as well as properties of the surrounding physical space, among the other spatial sound features.

The following disclosure proposes methods as how to convey LFE information alongside with the (direction and ratio) spatial parametrization. Thus for example in the case of multichannel loudspeaker input, the embodiments aim to faithfully reproduce the perception of the original LFE signal. In some embodiments in the case of microphone-array or Ambisonics input, apparatus and methods propose to determine a reasonable LFE related signal.

As the direction and direct-to-total energy ratio parametrization (in other words the direction-ratio parametrization) relates to the human perception of a sound field it aims to convey information that can be used to reproduce a sound field that is perceived equally as the original sound field. The parametrization is generic of the reproduction system in that it may be designed to adapt to loudspeaker reproduction with any loudspeaker setup and also headphone reproduction. Hence, such parametrization is useful with versatile audio codecs where the input can be from various sources (microphone-arrays, multichannel loudspeaker, Ambisonics) and the output can be to various reproduction systems (headphones, various loudspeaker setups).

However, as direction-ratio parametrization is independent of the reproduction system, it also means that there are no direct control of what audio should be reproduced from a certain loudspeaker. The direction-ratio parametrization determines directional distribution of the sound to be reproduced, which is typically enough for the broadband loudspeakers. But, LFE channel typically does not have any “direction”. Instead, it is simply a channel where the audio engineer has decided to put a certain amount of low-frequency energy.

In the following embodiments the LFE information may be generated. In the embodiments involving a multichannel input (e.g., 5.1), the LFE channel information may be readily available. However in some embodiments, for example microphone-array input, there is no LFE channel information (as microphones are capturing a real sound scene). Hence, the LFE channel information in some embodiments is generated or synthesized (in addition to encoding and transmitting this information).

The embodiments where the generation or synthesis of LFE is implemented enables a rendering system to avoid only using broadband loudspeakers to reproduce low frequencies and enable the use of a subwoofer or similar output device. Also the embodiments may allow the rendering or synthesis system to avoid the reproduction using a fixed energy portion of the low frequencies with the LFE speaker which may lose all directionality at those frequencies as there is typically only one LFE speaker. Whereas, with the embodiments as described herein, the LFE signal (which does not have directionality) can be reproduced with the LFE speaker, and other parts of the signal (which may have directionality) can be reproduced with the broadband speakers, thus maintaining the directionality.

Similar observations are valid also for other inputs such as Ambisonics input.

The concepts as expressed in the embodiments hereafter relates to audio encoding and decoding using a sound-field related parameterization (e.g., direction(s) and direct-to-total energy ratio(s) in frequency bands) where embodiments transmit (generated or received) low-frequency effects (LFE) channel information in addition to (broadband) audio signals with such parametrization. In some embodiments the transmission of the LFE channel (and broadband audio signals) information may be implemented by obtaining audio signals; computing the ratio of LFE energy and total energy of the audio signals in one or more frequency bands; determining direction and direct-to-total energy ratio parameters using the audio signals; transmitting these LFE-to-total energy ratio(s) alongside associated audio signal(s) and direction and direct-to-total energy ratio parameters. Furthermore in such embodiments the audio may be synthesized for the LFE channel using the LFE-to-total energy ratio(s) and the associated audio signal(s); and synthesizing the audio for the other channels using the LFE-to-total energy ratio(s), direction and direct-to-total energy ratio parameters, and associated audio signal(s).

The embodiments as disclosed herein furthermore present apparatus and methods for reproducing the ‘correct’ amount of energy associated with the LFE channel, thus maintaining the perception of the original sound scene.

In some embodiments the input audio signals to the system may be multichannel audio signals, microphone array signals, or Ambisonic audio signals.

The transmitted associated audio signals (1-N, for example 2 audio signals) may be obtained by any suitable means for example by downmixing, selecting, or processing the input audio signals.

The direction and direct-to-total energy ratio parameters may be determined using any suitable method or apparatus.

As discussed above in some embodiments where the input is a multichannel audio input, the LFE energy and the total energy can be estimated directly from the multichannel signals. However in some embodiments apparatus and methods are disclosed for determining LFE-to-total energy ratio(s) which may be used to generate suitable LFE information in the situations where LFE channel information is not received, for example microphone array or Ambisonics input. This may therefore be based on the analysed direct-to-total energy ratio: if the sound is directional, small LFE-to-total energy ratio; and if the sound is non-directional, large LFE-to-total energy ratio.

In some embodiments apparatus and methods are presented for transmitting the LFE information from multichannel signals alongside Ambisonic signals. This is based on the methods discussed in detail hereafter where transmission is performed alongside the sound-field related parameterization and associated audio signals, but in this case spatial aspects are transmitted using the Ambisonic signals, and the LFE information is transmitted using the LFE-to-total energy ratio.

Furthermore in some embodiments apparatus and methods are presented for transcoding a first data stream (audio and metadata), where metadata does not contain LFE-to-total energy ratio(s), to second data stream (audio and metadata), where synthesized LFE-to-total energy ratio(s) are injected to the metadata.

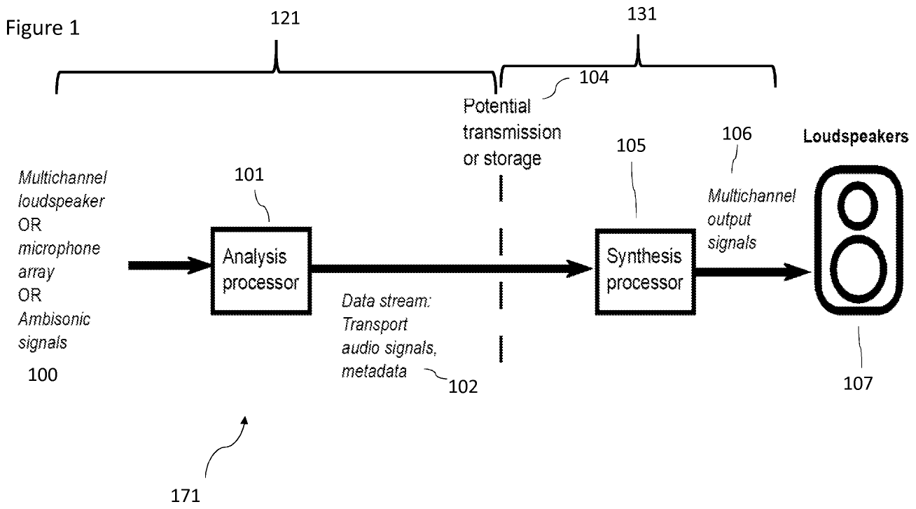

With respect to FIG. 1 an example apparatus and system for implementing embodiments of the application are shown. The system 171 is shown with an ‘analysis’ part 121 and a ‘synthesis’ part 131. The ‘analysis’ part 121 is the part from receiving the input (multichannel loudspeaker, microphone array, ambisonics) audio signals 100 up to an encoding of the metadata and transport signal 102 which may be transmitted or stored 104. The ‘synthesis’ part 131 may be the part from a decoding of the encoded metadata and transport signal 104 to the presentation of the re-generated signal (for example in multi-channel loudspeaker form 106 via loudspeakers 107.

The input to the system 171 and the ‘analysis’ part 121 is therefore audio signals 100. These may be suitable input multichannel loudspeaker audio signals, microphone array audio signals, or ambisonic audio signals.

The input audio signals 100 may be passed to an analysis processor 101. The analysis processor 101 may be configured to receive the input audio signals and generate a suitable data stream 104 comprising suitable transport signals. The transport audio signals may also be known as associated audio signals and be based on the audio signals. For example in some embodiments the transport signal generator 103 is configured to downmix or otherwise select or combine, for example, by beamforming techniques the input audio signals to a determined number of channels and output these as transport signals. In some embodiments the analysis processor is configured to generate a 2 audio channel output of the microphone array audio signals. The determined number of channels may be two or any suitable number of channels.

In some embodiments the analysis processor is configured to pass the received input audio signals 100 unprocessed to an encoder in the same manner as the transport signals. In some embodiments the analysis processor 101 is configured to select one or more of the microphone audio signals and output the selection as the transport signals 104. In some embodiments the analysis processor 101 is configured to apply any suitable encoding or quantization to the transport audio signals.

In some embodiments the analysis processor 101 is also configured to analyse the input audio signals 100 to produce metadata associated with the input audio signals (and thus associated with the transport signals). The analysis processor 101 can, for example, be a computer (running suitable software stored on memory and on at least one processor), mobile device, or alternatively a specific device utilizing, for example, FPGAs or ASICs. As shown herein in further detail the metadata may comprise, for each time-frequency analysis interval, a direction parameter, an energy ratio parameter and a low frequency effect channel parameter (and furthermore in some embodiments a surrounding coherence parameter, and a spread coherence parameter). The direction parameter and the energy ratio parameters may in some embodiments be considered to be spatial audio parameters. In other words the spatial audio parameters comprise parameters which aim to characterize the sound-field of the input audio signals.

In some embodiments the parameters generated may differ from frequency band to frequency band and may be particularly dependent on the transmission bit rate. Thus for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons.

The transport signals and the metadata 102 may be transmitted or stored, this is shown in FIG. 1 by the dashed line 104. Before the transport signals and the metadata are transmitted or stored they may in some embodiments be coded in order to reduce bit rate, and multiplexed to one stream. The encoding and the multiplexing may be implemented using any suitable scheme.

In the decoder side 131, the received or retrieved data (stream) may be input to a synthesis processor 105. The synthesis processor 105 may be configured to demultiplex the data (stream) to coded transport and metadata. The synthesis processor 105 may then decode any encoded streams in order to obtain the transport signals and the metadata.

The synthesis processor 105 may then be configured to receive the transport signals and the metadata and create a suitable multi-channel audio signal output 106 (which may be any suitable output format such as binaural, multi-channel loudspeaker or Ambisonics signals, depending on the use case) based on the transport signals and the metadata. In some embodiments with loudspeaker reproduction, an actual physical sound field is reproduced (using the loudspeakers 107) having the desired perceptual properties. In other embodiments, the reproduction of a sound field may be understood to refer to reproducing perceptual properties of a sound field by other means than reproducing an actual physical sound field in a space. For example, the desired perceptual properties of a sound field can be reproduced over headphones using the binaural reproduction methods as described herein. In another example, the perceptual properties of a sound field could be reproduced as an Ambisonic output signal, and these Ambisonic signals can be reproduced with Ambisonic decoding methods to provide for example a binaural output with the desired perceptual properties.

The synthesis processor 105 can in some embodiments be a computer (running suitable software stored on memory and on at least one processor), mobile device, or alternatively a specific device utilizing, for example, FPGAs or ASICs.

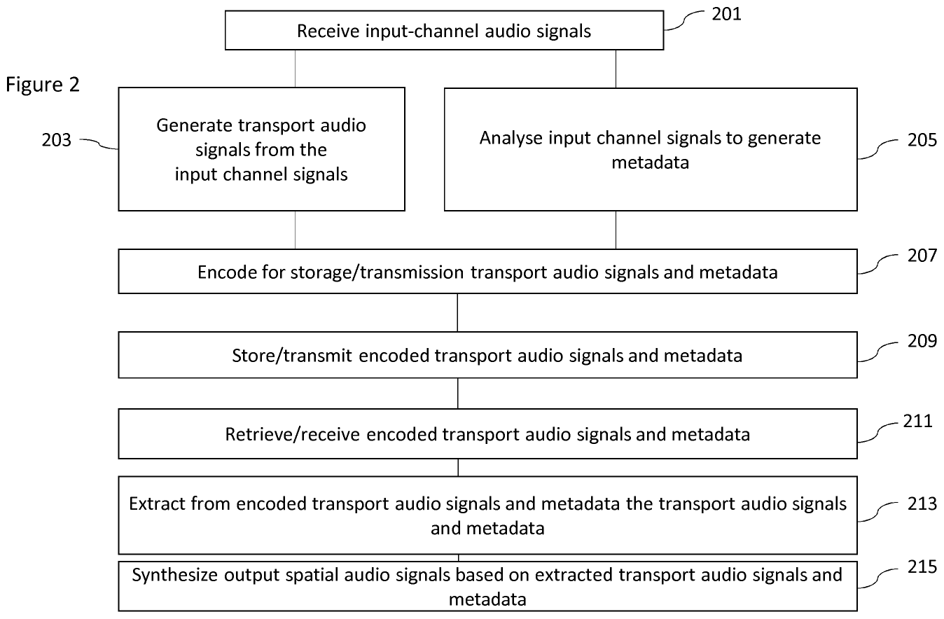

With respect to FIG. 2 an example flow diagram of the overview shown in FIG. 1 is shown.

First the system (analysis part) is configured to receive input audio signals or suitable multichannel input as shown in FIG. 2 by step 201.

Then the system (analysis part) is configured to generate a transport signal channels or transport signals (for example downmix/selection/beamforming based on the multichannel input audio signals) as shown in FIG. 2 by step 203.

Also the system (analysis part) is configured to analyse the audio signals to generate metadata: Directions; Energy ratios, LFE ratios (and in some embodiments other metadata such as Surrounding coherences; Spread coherences) as shown in FIG. 2 by step 205.

The system is then configured to (optionally) encode for storage/transmission the transport signals and metadata with coherence parameters as shown in FIG. 2 by step 207.

After this the system may store/transmit the transport signals and metadata (which may include coherence parameters) as shown in FIG. 2 by step 209.

The system may retrieve/receive the transport signals and metadata as shown in FIG. 2 by step 211.

Then the system is configured to extract from the transport signals and metadata as shown in FIG. 2 by step 213.

The system (synthesis part) is configured to synthesize an output spatial audio signals (which as discussed earlier may be any suitable output format such as binaural, multi-channel loudspeaker or Ambisonics signals, depending on the use case) based on extracted audio signals and metadata as shown in FIG. 2 by step 215.

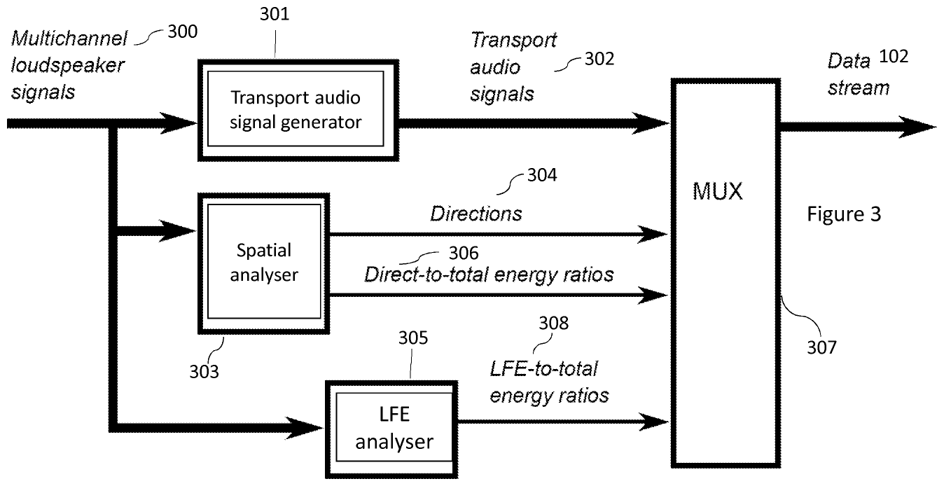

With respect to FIG. 3 an example analysis processor 101 according to some embodiments where the input audio signal is a multichannel loudspeaker input is shown. The multichannel loudspeaker signals 300 in this example are passed to a transport audio signal generator 301. The transport audio signal generator 301 is configured to generate the transport audio signals according to any of the options described previously. For example the transport audio signals may be downmixed from the input signals. The number of the transport audio signals may be any number and may be 2 or more or fewer than 2.

In the example shown in FIG. 3 the multichannel loudspeaker signals 300 are also input to a spatial analyser 303. The spatial analyser 303 may be configured to generate suitable spatial metadata outputs such as shown as the directions 304 and direct-to-total energy ratios 306. The implementation of the analysis may be any suitable implementation and, as long as it can provide direction for example azimuth ∝(k,n) and direct-to-total energy ratio r(k,n) in a time-frequency domain (k is the frequency band index and n the temporal frame index).

For example in some embodiments the spatial analyser 303 transforms the multi-channel loudspeaker signals to a first-order Ambisonics (FOA) signal and the direction and ratio estimation is performed in the time-frequency domain.

A FOA signal consists of four signals: The omnidirectional w(t), and three figure-of-eight patterns x(t), y(t) and z(t), aligned orthogonally. Let us assume them in a time-frequency transformed form: w(k,n), x(k,n), y(k,n), z(k,n). SN3D normalization scheme is used, where the maximum directional response for each of the patterns is 1.

From the FOA signal, it is possible to estimate a vector that points towards the direction-of-arrival

$${v}_{θ} ( k , n ) = 〈 w ( k , n ) [ \begin{matrix}x ( k , n ) \\ y ( k , n ) \\ z ( k , n )\end{matrix} ] 〉 .$$

The direction of this vector is the direction θ(k,n). The brackets <.> denote potential averaging over time and/or frequency. Note that when averaged, the direction data may not need to be expressed or stored for every time and frequency sample.

A ratio parameter can be obtained by

$$r ( k , n ) = \frac{\vert {v}_{θ} ( k , n ) \vert}{〈 0.5 ( {w}^{2} ( k , n ) + {x}^{2} ( k , n ) + {y}^{2} ( k , n ) + {z}^{2} ( k , n ) ) 〉} .$$

To utilize the above formulas for the loudspeaker input, then the loudspeaker signals sᵢ(t) where i is the channel index can be transformed into the FOA signals by

$${FOA}_{i} ( t ) = [ \begin{matrix}{w}_{i} ( t ) \\ {x}_{i} ( t ) \\ {y}_{i} ( t ) \\ {z}_{i} ( t )\end{matrix} ] = {s}_{i} ( t ) [ \begin{matrix}1 \\ cos ( {azi}_{i} ) cos ( {ele}_{i} ) \\ sin ( {azi}_{i} ) cos ( {ele}_{i} ) \\ sin ( {ele}_{i} )\end{matrix} ]$$

The w, x, y, and z signals are generated for each loudspeaker signal sᵢ having its own azimuth and elevation direction. The output signal combining all such signals is Σᵢ₌₁^{NUM_CH} FOAᵢ(t).

The multichannel loudspeaker signals 300 may also be input to a LFE analyser 305. The LFE analyser 305 may be configured to generate LFE-to-total energy ratios 308 (which may also be known generally as low or lower frequency to total energy ratios).

The spatial analyser may further comprise a multiplexer 307 configured to combine and encode the transport audio signals 302, the directions 304, the direct-to-total energy ratios 306 and LFE-to-total energy ratios 308 to generate the data stream 102. The multiplexer 307 may be configured to compress the audio signals using a suitable codec (e.g., AAC or EVS) and furthermore compress the metadata as described above.

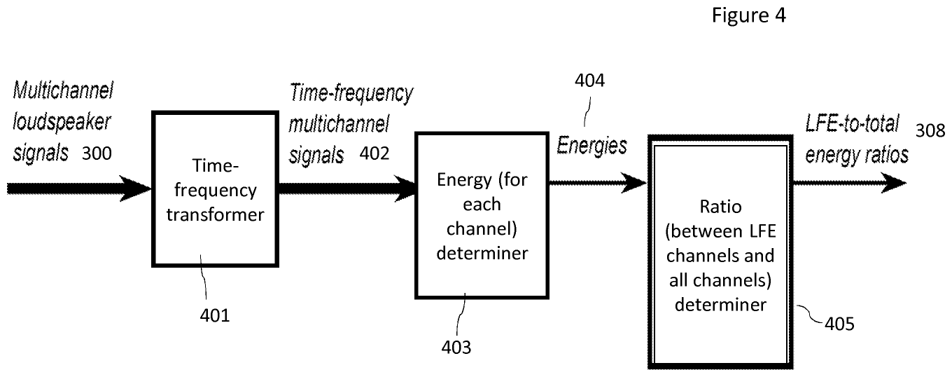

With respect to FIG. 4 is shown the example LFE analyser 305 as shown previously in FIG. 3.

The example LFE analyser 305 may comprise a time-frequency transformer 401 configured to receive the multichannel loudspeaker signals and transform the multichannel loudspeaker signals to the time-frequency domain, using a suitable transform (for example a short-time Fourier transform (STFT), complex-modulated quadrature mirror filterbank (QMF), or hybrid QMF that is the complex QMF bank with cascaded band-division filters at the lowest frequency bands to improve the frequency resolution). The resulting signals may be denoted as Sᵢ(b,n), where i is the loudspeaker channel, b the frequency bin index, and n temporal frame index.

In some embodiments the LFE analyser 305 may comprise an energy (for each channel) determiner 403 configured to receive the time-frequency audio signals and determine an energy of each channel by

Eᵢ(b,n)=Sᵢ(b,n)²

The energies of the frequency bins may be grouped into frequency bands that group one or more of the bins into a band index k=0, . . . , K−1

$${E}_{i} ( k , n ) = {\sum }_{{b}_{k , low}}^{{b}_{k , high}} {E}_{i} ( b , n )$$

Each frequency band k has a lowest bin b_{k,low} and a highest bin b_{k,high}, and the frequency band contains all bins from b_{k,low} to b_{k,high}. The widths of the frequency bands can approximate any suitable distribution. For example, the equivalent rectangular bandwidth (ERB) scale or the Bark scale are typically used in spatial-audio processing.

In some embodiments the LFE analyser 305 may comprise a ratio (between LFE channels and all channels) determiner 405 configured to receive the energies 404 from the energy determiner 403. The ratio (between LFE channels and all channels) determiner 405 may be configured to determine the LFE-to-total energy ratio by selecting the frequency bands at low frequencies in a way that the perception of LFE is preserved. For example in some embodiments two bands may be selected at low frequencies (0-60 and 60-120 Hz), or, if minimal bitrate is desired, only one band may be used (0-120 Hz). In some embodiments a larger number of bands may be used, the frequency borders of the bands may be different or may overlap partially. Furthermore in some embodiments the energy estimates may be averaged over the time axis.

The LFE-to-total energy ratio Ξ(k,n) may then be computed as the ratio of the sum of the energies of the LFE channels and the sum of the energies all channels, for example by using the following calculation:

$$Ξ ( k , n ) = \frac{{\sum }_{i ∈ LFE} {E}_{i} ( k , n )}{{\sum }_{i} {E}_{i} ( k , n )}$$

The LFE-to-total energy ratios Ξ(k,n) 308 may then be output.

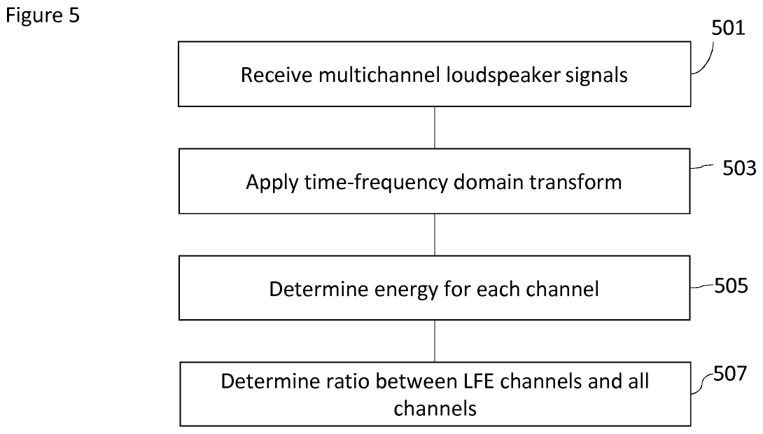

With respect to FIG. 5 is shown a flow diagram of the operation of the LFE analyser 305.

The first operation is one of receiving the multichannel loudspeaker audio signals as shown in FIG. 5 by step 501.

The following operation is one of applying a time-frequency domain transform to the multichannel loudspeaker signals as shown in FIG. 5 by step 503.

Then the energy for each channel is determined as shown in FIG. 5 by step 505.

Finally the ratio between the LFE channels and all channels is determined and output as shown in FIG. 5 by step 507.

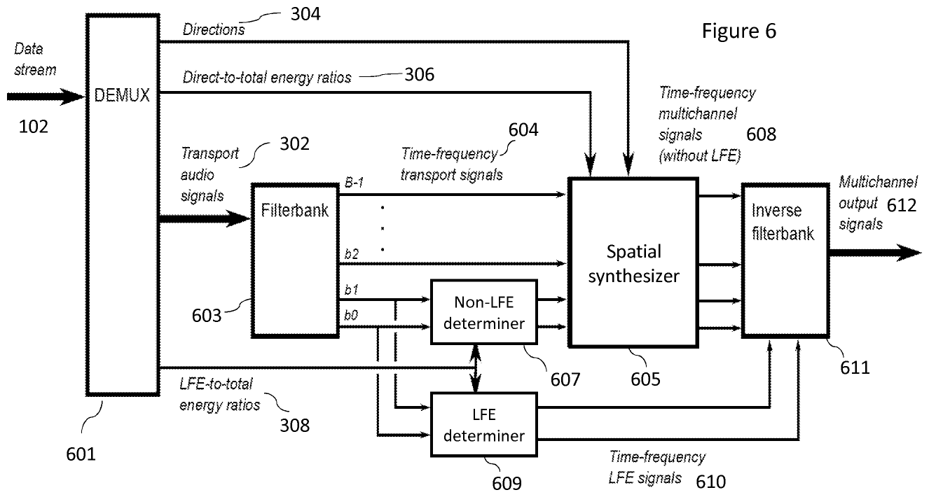

With respect to FIG. 6 is shown an example synthesis processor 105 suitable for processing the output of the multiplexer according to some embodiments.

The synthesis processor 105 as shown in FIG. 6 shows a de-multiplexer 601. The de-multiplexer 601 is configured to receive the data stream 102 and de-multiplex and/or decompression or decoding of the audio signals and/or the metadata.

The transport audio signals 302 may then be output to a filterbank 603. The filterbank 603 may be configured to perform a time-frequency transform (for example a STFT or complex QMF). The filterbank 603 is configured to have enough frequency resolution at low frequencies so that audio can be processed according to the frequency resolution of the LFE-to-total energy ratios. For example in the case of a complex QMF filterbank implementation, if the frequency resolution is not good enough (i.e., the frequency bins are too wide in frequency), the frequency bins may be further divided in low frequencies to narrower bands using cascaded filters, and the high frequencies may be correspondingly delayed. Thus in some embodiments a hybrid QMF may implement this approach.

In some embodiments the LFE-to-total energy ratios 308 output by the de-multiplexer 601 are for two frequency bands (associated with filterbank bands b₀ and b₁). The filterbank transforms the signal so that the two (or any defined number identifying the LFE frequency range) lowest bins of the time-frequency domain transport audio signal Tᵢ(b,n) correspond to these frequency bands and are input to a Non-LFE determiner 607 which is also configured to receive the LFE-to-total energy ratios.

The Non-LFE determiner 607 is configured to modify the bins output by the filterbank 603 based on the ratio values. For example the Non-LFE determiner 607 is configured to apply the following modification

Tᵢ′(b,n)=Tᵢ(b,n)(1−Ξ(b,n))^{p}

where p could be 1.

The modified low-frequency bins Tᵢ′(b,n) and the unmodified bins Tᵢ(b,n) at other frequencies may be input to a spatial synthesizer 605 which is configured to receive also the directions and the direct-to-total energy ratios.

Any suitable spatial audio synthesis method may be employed by the spatial synthesizer 605 to then render the multichannel loudspeaker signals Mᵢ(b,n) (e.g., for 5.1). These signals do not have any content in the LFE channel (in other words the LFE channel contains only zeros from the spatial synthesizer).

In some embodiments the synthesis processor further comprises a LFE determiner 609 configured to receive the (two or other defined number) lowest bins of the transport audio signal Tᵢ(b,n) and the LFE-to-total energy ratios. The LFE determiner 609 may then be configured to generate the LFE channel, for example by calculating

$$L ( b , n ) = {( Ξ ( b , n ) )}^{p} {\sum }_{i} {T}_{i} ( b , n )$$

In some embodiments an inverse filterbank 611 is configured to receive the multichannel loudspeaker signals from the spatial synthesizer 605 and the LFE signal time-frequency signals 610 output from the LFE determiner 609. These signals may be combined or merged them and further are converted to the time domain.

The resulting multichannel loudspeaker signals (e.g., 5.1) 612 may be reproduced using a loudspeaker setup.

In some embodiments there could be more than one LFE channel. In such embodiments there may be more than one LFE-to-total ratio (in other words one for each LFE channel). Before synthesizing the multi-channel sound without LFE signal the energy of all LFE channels is subtracted from the signals. Furthermore, multiple LFE signals L(b, n) are extracted from signals Tᵢ(b,n) using their own LFE-to-total ratio parameters Ξ(b,n).

In some embodiments the LFE content, according to a single LFE-to-total energy ratio, is evenly distributed to all LFE channels, or (partially) panned based on the direction θ(k,n) using, e.g., vector-base amplitude panning (VBAP).

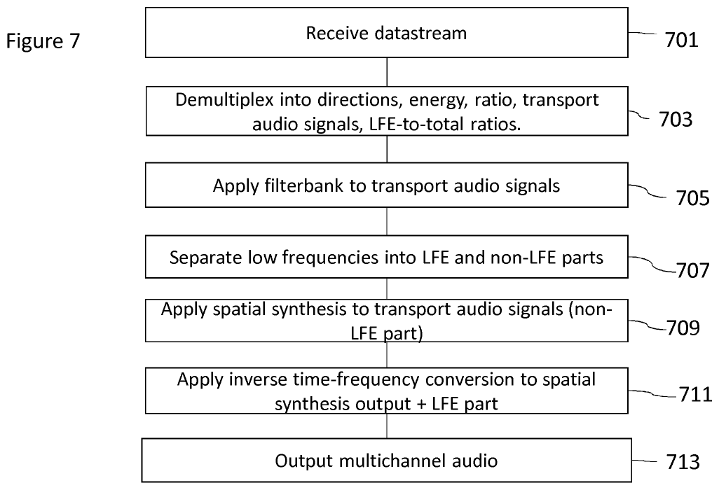

The operations of the synthesis processor shown in FIG. 6 are shown in FIG. 7.

The first operation is one of receiving the datastream as shown in FIG. 7 by step 701.

The datastream may then be demultiplexed into transport audio signals and the associated metadata such as directions, energy ratios, and LFE-to-total ratios as shown in FIG. 7 by step 703.

The transport audio signals may be filtered into frequency bands as shown in FIG. 7 by step 705.

The low frequencies generated by the filterbank may then be separated into LFE and non-LFE parts as shown in FIG. 7 by step 707.

The transport audio signals including the non-LFE parts of the low frequencies may then be spatially processed based on the directions and energy ratios as shown in FIG. 7 by step 709.

The LFE parts and spatially processed transport audio signals (including the non-LFE parts) may then be combined and inverse time-frequency domain transformed to generate the multichannel audio signals as shown in FIG. 7 by step 711.

The multichannel audio signals may then be output as shown in FIG. 7 by step 713.

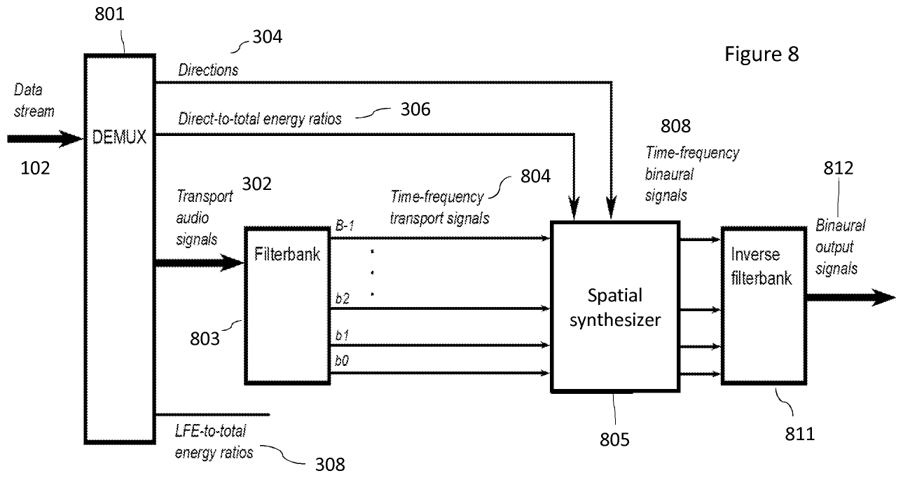

With respect to FIG. 8 is shown an example synthesis processor configured to generate binaural output signals. FIG. 8 is similar to the synthesis processor example shown in FIG. 6. The de-multiplexer 801 is configured to receive the data stream 102 and demultiplex and/or decompression or decoding of the audio signals and/or the metadata. The transport audio signals 302 may then be output to a filterbank 803. The filterbank 803 may be configured to perform a time-frequency transform (for example a STFT or complex QMF).

The difference between the example synthesis processor shown in FIGS. 6 and 8 is that the LFE-to-total energy ratios 308 output by the de-multiplexer 801 is not used. The filterbank therefore outputs the time-frequency transform signals to a spatial synthesizer 805.

Any suitable spatial audio synthesis method may be employed by the spatial synthesizer 805 to then render the binaural signals 808.

In some embodiments an inverse filterbank 811 is configured to receive the binaural signals 808 from the spatial synthesizer 805. These signals may be converted to the time domain and the resulting binaural output signals 812 output to the suitable binaural playback apparatus—for example headphones, earphones etc. Hence, the disclosed LFE handling method is fully compatible also with other kinds of outputs than the multichannel loudspeaker output.

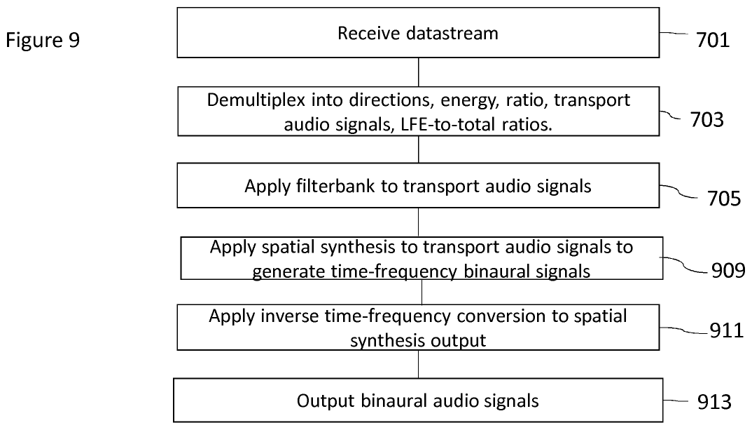

The operations of the synthesis processor shown in FIG. 8 are shown in FIG. 9.

The first operation is one of receiving the datastream as shown in FIG. 9 by step 701.

The datastream may then be demultiplexed into transport audio signals and the associated metadata such as directions, energy ratios, and LFE-to-total ratios as shown in FIG. 9 by step 703.

The transport audio signals may be filtered into frequency bands as shown in FIG. 9 by step 705.

The transport audio signals may then be spatially processed based on the directions and energy ratios to generate time-frequency binaural signals as shown in FIG. 9 by step 909.

The time-frequency binaural signals (spatially processed transport audio signals) may then be combined and inverse time-frequency domain transformed to generate the time domain binaural audio signals as shown in FIG. 9 by step 911.

The time domain binaural audio signals may then be output as shown in FIG. 9 by step 913.

In some embodiments, an alternative way to synthesize the binaural sound is similar to the synthesis processor shown in FIG. 6, where the LFE channel is separated. However, at the binaural synthesis stage, the LFE channel (or channels) could be reproduced to left and right ears coherently without binaural head-tracking, and the remainder of the spatial sound output could be synthesized with head-tracked binaural reproduction.

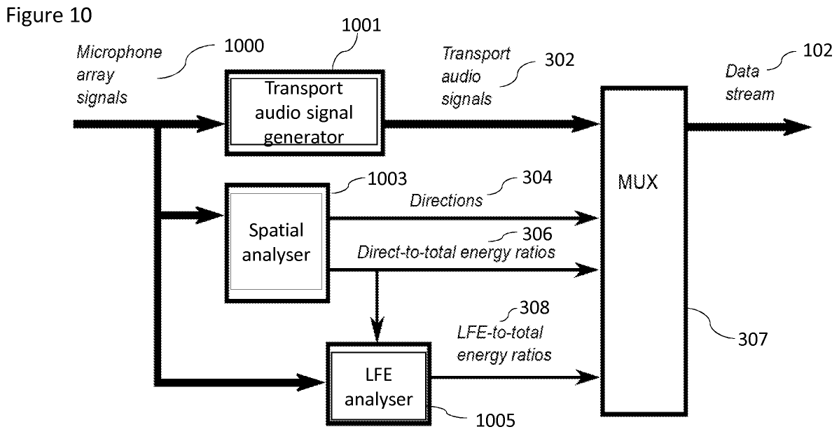

With respect to FIG. 10 a further example analysis processor 101 according to some embodiments where the input audio signal is a microphone array signals input is shown. The microphone array signal 1000 in this example are passed to a transport audio signal generator 1001. The transport audio signal generator 1001 is configured to generate the transport audio signals according to any of the options described previously. For example the transport audio signals may be downmixed from the input signals. The transport audio signals may furthermore in some embodiments be selected from the input microphone signals. In addition, the microphone signals may be processed in any suitable way (e.g., equalized). The number of the transport audio signals may be any number and may be 2 or more than or fewer than 2.

In the example shown in FIG. 10 the microphone array signals 1000 are also input to a spatial analyser 1003. The spatial analyser 1003 may be configured to generate suitable spatial metadata outputs such as shown as the directions 304 and direct-to-total energy ratios 306. The implementation of the analysis may be any suitable implementation (e.g., spatial audio capture), as long as it can provide direction for example azimuth θ(k,n) and direct-to-total energy ratio r (k,n) in a time-frequency domain (k is the frequency band index and n the temporal frame index).

The microphone array signals 1000 may also be input to a LFE analyser 1005. The LFE analyser 1005 may be configured to generate LFE-to-total energy ratios 308.

The spatial analyser may further comprise a multiplexer 307 configured to combine and encode the transport audio signals 302, the directions 304, the direct-to-total energy ratios 306 and LFE-to-total energy ratios 308 to generate the data stream 102. The multiplexer 307 may be configured to compress the audio signals using a suitable codec (e.g., AAC or EVS) and furthermore compress the metadata as described above.

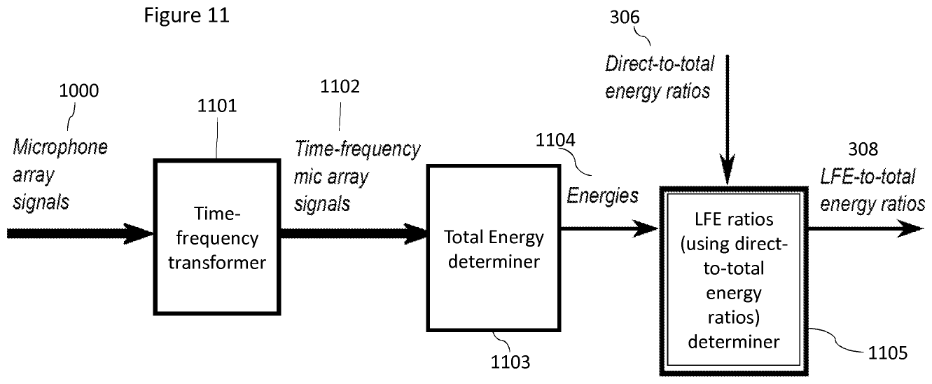

With respect to FIG. 11 is shown the example LFE analyser 1005 as shown previously in FIG. 10.

The example LFE analyser 1005 may comprise a time-frequency transformer 1101 configured to receive the multichannel loudspeaker signals and transform the multichannel loudspeaker signals to the time-frequency domain, using a suitable transform (for example a short-time Fourier transform (STFT), complex-modulated quadrature mirror filterbank (QMF), or hybrid QMF that is the complex QMF bank with cascaded band-division filters at the lowest frequency bands to improve the frequency resolution). The resulting signals may be denoted as Sᵢ(b,n), where i is the microphone channel, b the frequency bin index, and n temporal frame index.

In some embodiments the LFE analyser 1005 may comprise an energy (total) determiner 1103 configured to receive the time-frequency audio signals and determine a total energy by

$$E ( b , n ) = {\sum }_{i} {{S}_{i} ( b , n )}^{2}$$

The energies of the frequency bins may be grouped into frequency bands that group one or more of the bins into a band index k=0, . . . , K−1

$$E ( k , n ) = {{\sum }^{{b}_{k , high}}}_{{b}_{k , low}} E ( b , n )$$

Each frequency band k has a lowest bin b_{k,low} and a highest bin b_{k,high}, and the frequency band contains all bins from b_{k,low} to b_{k,high}. The widths of the frequency bands can approximate any suitable distribution. For example, the equivalent rectangular bandwidth (ERB) scale or the Bark scale are typically used in spatial-audio processing. In some embodiments the energy values could be averaged over time as well. As described previously, in the case of microphone-array inputs, there is no ‘actual’ LFE channel available. In such embodiments it needs to be determined and the example disclosed herein is that the level of LFE should be determined based on the directionality of the sound field. If the sound field is very directional, it is important to reproduce the sound from the right direction. In that case, more sound should be reproduced with the broadband loudspeakers (LFE speaker cannot reproduce the direction). On the contrary, if the sound field is very non-directional, the sound may be reproduced using the LFE channel (that loses the direction information, but can better reproduce the lowest frequencies, since a subwoofer is typically used). Moreover, the distribution between the LFE and broadband energy may be dependent on the frequency, since human hearing is less sensitive to direction the lower the frequency.

In some embodiments the LFE analyser 1005 may comprise a (LFE-to-total) ratio (using direct to total energy ratios) determiner 1105 configured to receive the energies 1104 from the energy determiner 1103 and the direct-to-total energy ratios 306. The ratio determiner 1105 may be configured to determine the LFE-to-total energy ratio by:

Ξ(k,n)=α(k)+β(k)(1−r(k,n))

Suitable values for α and β include, e.g., α(0)=0.5, α(1)=0.2, β(0)=0.4, and β(1)=0.4. This effectively sets more energy to LFE the lower the frequency is and the less directional the sound is. The resulting LFE-to-total energy ratio Ξ(k,n) values may be smoothed over time (e.g., using first-order IIR smoothing), typically weighted with energy Ξ(k,n). The (smoothed) LFE-to-total energy ratio(s) 308 Ξ(k,n) is/are then output.

In some embodiments a weighted energy smoothing is employed such as by calculating

$${Ξ}_{smooth} ( k , n ) = \frac{A ( k , n )}{B ( k , n )} , \\ where A ( k , n ) = A ( k , n - 1 ) * f + E ( k , n ) Ξ ( k , n )$$

$$B ( k , n ) = B ( k , n - 1 ) * f + E ( k , n )$$

where factor f could be 0.5, and A(k,0)=eps and B(k,0)=eps for each k, where eps is a small value.

In some embodiments the LFE-to-total energy ratio 308 could be analysed using the fluctuation of the direction parameter instead of the direct-to-total energy ratio.

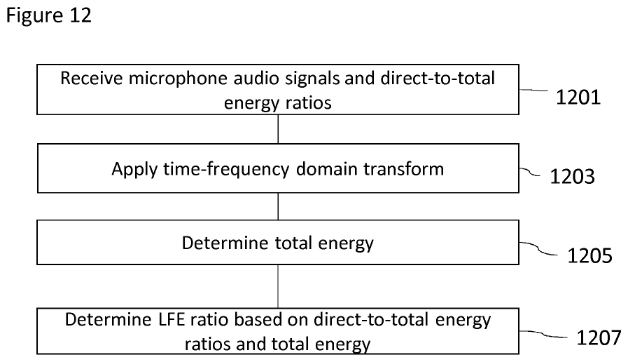

With respect to FIG. 12 is shown a flow diagram of the operation of the LFE analyser 1005 shown in FIG. 11.

The first operation is one of receiving the microphone array audio signals and direct-to-total energy ratios as shown in FIG. 12 by step 1201.

The following operation is one of applying a time-frequency domain transform to the microphone array audio signals as shown in FIG. 12 by step 1203.

Then the total energy is determined as shown in FIG. 12 by step 1205.

Finally the LFE to total energy ratio is determined based on the direct-to-total energy ratio and total energy as shown in FIG. 12 by step 1207.

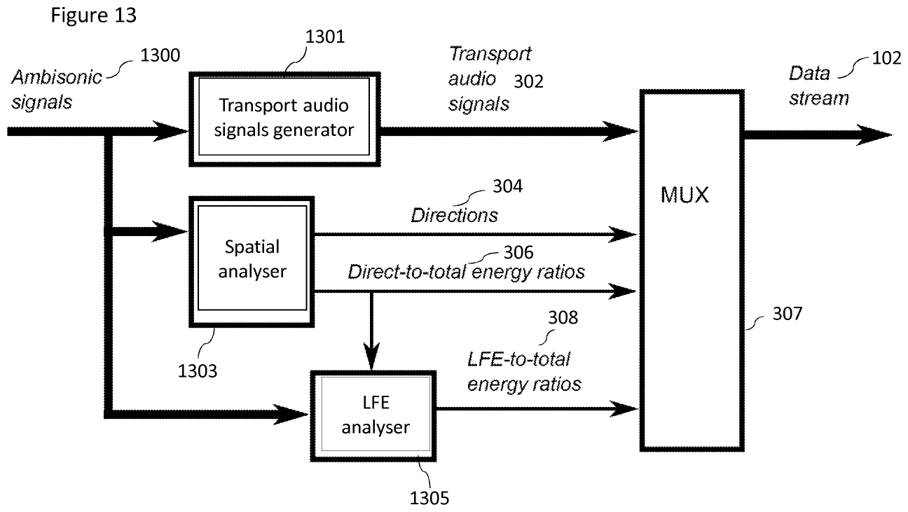

With respect to FIG. 13 a further example analysis processor 101 according to some embodiments where the input audio signal is an ambisonic signals input 1300 is shown. Although the following examples describe examples of first-order ambisonics, higher-order ambisonics may be used. The ambisonic signals 1300 in this example are passed to a transport audio signal generator 1301. The transport audio signal generator 1301 is configured to generate the transport audio signals according to any of the options described previously. For example the transport audio signals may be based on beamforming, for instance by generating for example left and right cardioid signals based on the FOA signal.

In the example shown in FIG. 13 the ambisonic signals 1300 are also input to a spatial analyser 1303. The spatial analyser 1303 may be configured to generate suitable spatial metadata outputs such as shown as the directions 304 and direct-to-total energy ratios 306. The implementation of the analysis may be any suitable implementation, for example such as described above with respect to FIG. 3 where it is configured to provide directions, for example azimuth θ(k,n), and direct-to-total energy ratios r(k,n) in a time-frequency domain (k is the frequency band index and n the temporal frame index).

The ambisonic signals 1300 may also be input to a LFE analyser 1305. The LFE analyser 1305 may be configured to generate LFE-to-total energy ratios 308.

The spatial analyser may further comprise a multiplexer 307 configured to combine and encode the transport audio signals 302, the directions 304, the direct-to-total energy ratios 306 and LFE-to-total energy ratios 308 to generate the data stream 102. The multiplexer 307 may be configured to compress the audio signals using a suitable codec (e.g., AAC or EVS) and furthermore compress the metadata as described above.

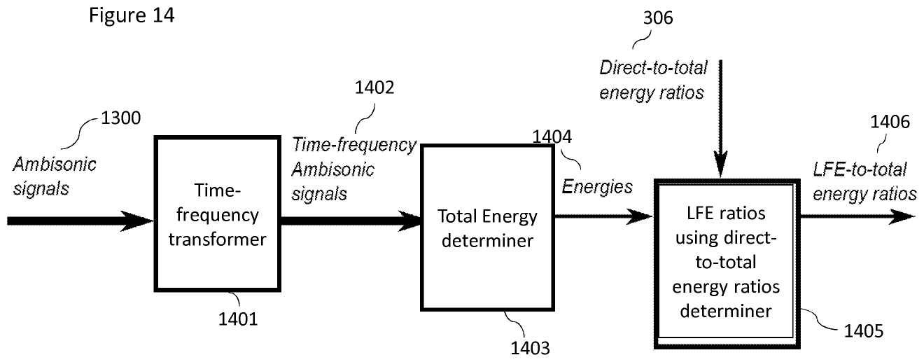

With respect to FIG. 14 is shown the example LFE analyser 1305 as shown previously in FIG. 13.

The example LFE analyser 1305 may comprise a time-frequency transformer 1401 configured to receive the multichannel loudspeaker signals and transform the multichannel loudspeaker signals to the time-frequency domain, using a suitable transform (for example a short-time Fourier transform (STFT), complex-modulated quadrature mirror filterbank (QMF), or hybrid QMF that is the complex QMF bank with cascaded band-division filters at the lowest frequency bands to improve the frequency resolution). The resulting signals may be denoted as Sᵢ(b,n), where i is the ambisonic channel, b the frequency bin index, and n temporal frame index.

In some embodiments the LFE analyser 1305 may comprise an energy (total) determiner 1403 configured to receive the time-frequency audio signals and determine a total energy by

$$E ( b , n ) = {\sum }_{i} {{S}_{i} ( b , n )}^{2}$$

The energies of the frequency bins may be grouped into frequency bands that group one or more of the bins into a band index k=0, . . . , K−1

$$E ( k , n ) = {{\sum }^{{b}_{k , high}}}_{{b}_{k , low}} E ( b , n )$$

In other words the FOA signal overall energy can be estimated as the sum energy of the FOA signals. In some embodiments the FOA signal overall energy can be estimated by estimating the energy of the omnidirectional component of the FOA signal.

Each frequency band k has a lowest bin b_{k,low} and a highest bin b_{k,high}, and the frequency band contains all bins from b_{k,low} to b_{k,high}. The widths of the frequency bands can approximate any suitable distribution. For example, the equivalent rectangular bandwidth (ERB) scale or the Bark scale are typically used in spatial-audio processing. In some embodiments the energy values could be averaged over time as well. As described previously, in the case of ambisonic audio inputs, there is no ‘actual’ LFE channel available and the values generated to attempt to achieve the same results as before.

In some embodiments therefore the LFE analyser 1305 may comprise a (LFE-to-total) ratio (using direct to total energy ratios) determiner 1405 configured to receive the energies 1404 from the energy determiner 1403 and the direct-to-total energy ratios 306. The ratio determiner 1405 may be configured to determine the LFE-to-total energy ratio by:

Ξ(k,n)=α(k)+β(k)(1−r(k,n))

Suitable values for α and β include, e.g., α(0)=0.5, α(1)=0.2, β(0)=0.4, and β(1)=0.4. This effectively sets more energy to LFE the lower the frequency is and the less directional the sound is. The resulting LFE-to-total energy ratio Ξ(k,n) values may be smoothed over time (e.g., using first-order IIR smoothing), typically weighted with energy Ξ(k,n). The (smoothed) LFE-to-total energy ratio(s) 308 Ξ(k,n) is/are then output.

In some embodiments a weighted energy smoothing is employed such as by calculating

$${Ξ}_{smooth} ( k , n ) = \frac{A ( k , n )}{B ( k , n )} , \\ where A ( k , n ) = A ( k , n - 1 ) * f + E ( k , n ) Ξ ( k , n )$$

$$B ( k , n ) = B ( k , n - 1 ) * f + E ( k , n )$$

where factor f could be 0.5, and A(k,0)=eps and B(k,0)=eps for each k, where eps is a small value.

In some embodiments the LFE-to-total energy ratio 308 could be analysed using the fluctuation of the direction parameter instead of the direct-to-total energy ratio.

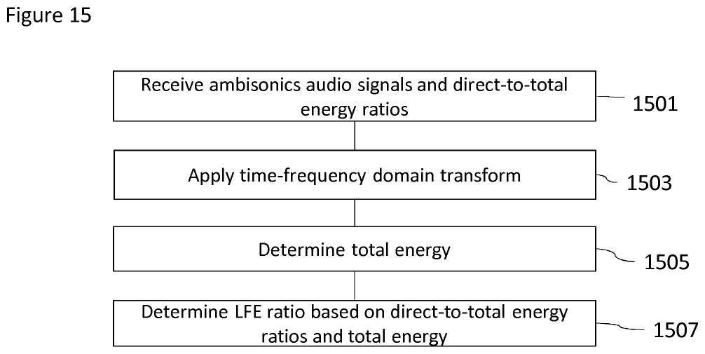

With respect to FIG. 15 is shown a flow diagram of the operation of the LFE analyser 1305 shown in FIG. 14.

The first operation is one of receiving the ambisonics audio signals and direct-to-total energy ratios as shown in FIG. 15 by step 1501.

The following operation is one of applying a time-frequency domain transform to the ambisonic signals as shown in FIG. 15 by step 1503.

Then the total energy is determined as shown in FIG. 15 by step 1505.

Finally the LFE to total energy ratio is determined based on the direct-to-total energy ratio and total energy as shown in FIG. 15 by step 1507.

In some embodiments rather than transmitting LFE ratio metadata with spatial metadata and transport audio signals the system may be configured to transmit ambisonic signals and LFE ratio metadata.

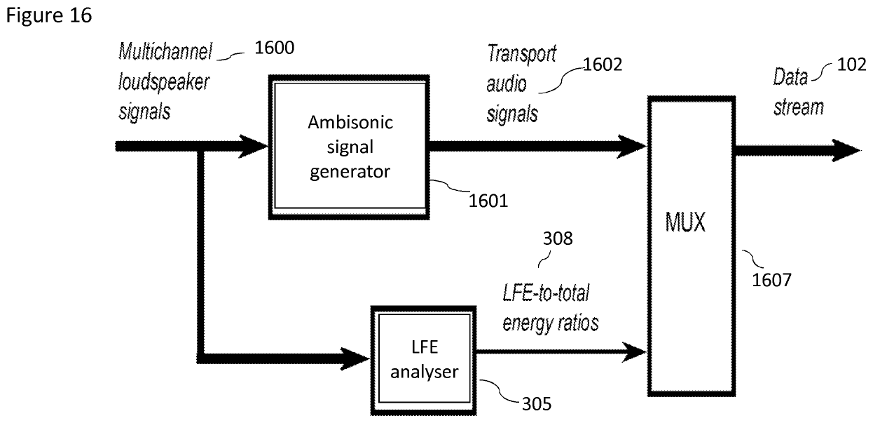

With respect to FIG. 16 is shown a further example analysis processor 101 according to some embodiments where the input audio signal is a multichannel loudspeaker signals input 1600. In this example the transport audio signal generator is an ambisonic signal generator 1601 configured to generate transport audio signals 1602 in the form of ambisonic audio signals. In other words the ambisonic signal generator 1601 converts the multichannel audio signals into ambisonic audio signals (for example FOA signals).

In such embodiments the LFE analyser 305 may be the same as described previously in the earlier embodiments receiving the multichannel loudspeaker audio signals.

In such embodiments the multiplexer 1607 may then receive the ambisonic signals and the LFE-to-total energy ratios and multiplex these to a data stream that is outputted from the analysis processor. Moreover the multiplexer 1607 may be configured to compress the audio signals (e.g., AAC or EVS) and the metadata.

The data stream may then be forwarded to a synthesis processor. In between, the data stream may have been stored and/or transmitted to another device.

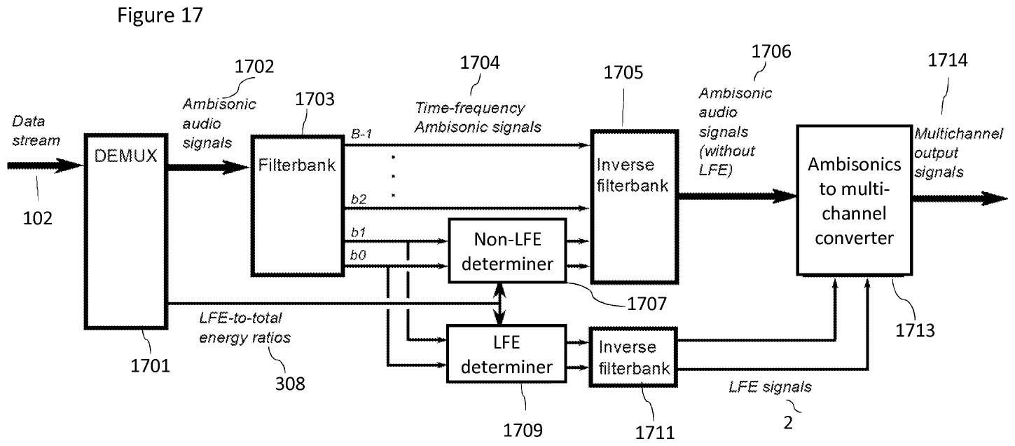

With respect to FIG. 17 an example synthesis processor configured to process the data stream 102 received from the analysis processor, the data stream comprising the ambisonic audio signals and the LFE-to-total energy ratios and generating multichannel (loudspeaker) output signals.

The synthesis processor as shown in FIG. 17 shows a de-multiplexer 1701. The de-multiplexer 1701 is configured to receive the data stream 102 and de-multiplex and/or decompress or decode the ambisonic audio signals 1702 and/or the metadata comprising the LFE-to-total-energy ratios 308.

The ambisonic audio signals 1702 may then be output to a filterbank 1703. The filterbank 1703 may be configured to perform a time-frequency transform (for example a STFT or complex QMF) and generate time-frequency ambisonic signals 1704. The filterbank 1703 is configured to have enough frequency resolution at low frequencies so that audio can be processed according to the frequency resolution of the LFE-to-total energy ratios. In some embodiments the frequencies above the LFE frequencies are not divided in other words in some embodiments the filterbank can be designed to divide only the LFE frequencies to separate bands.

In some embodiments the LFE-to-total energy ratios 308 output by the de-multiplexer 1701 are for two frequency bands (associated with filterbank bands b₀ and b₁). The filterbank transforms the signal so that the two (or the defined number representing the LFE frequency range) lowest bins of the time-frequency domain transport audio signal Tᵢ(b,n) correspond to these frequency bands and are input to a Non-LFE determiner 1707 which is also configured to receive the LFE-to-total energy ratios.

The Non-LFE determiner 1707 is configured to modify the bins output by the filterbank 1703 based on the ratio values. For example the Non-LFE determiner 1707 is configured to apply the following modification

Tᵢ′(b,n)=Tᵢ(b,n)(1−Ξ(b,n))^{p}

where p could be 1.

The modified low-frequency bins Tᵢ′(b,n) and the unmodified bins T ᵢ(b,n) at other frequencies may be input to an inverse filterbank 1705.

The inverse filterbank 1705 is configured to convert the received signals to ambisonic audio signals (without LFE) 1706 which may then be output to an ambisonics to multichannel converter 1713.

In some embodiments the synthesis processor further comprises a LFE determiner 1709 configured to receive the (two or other defined number) lowest bins of the filterbank output (the time-frequency ambisonic signals 1704) and the LFE-to-total energy ratios. The LFE determiner 1709 may then be configured to generate the LFE channel, for example by calculating

$$L ( b , n ) = {( Ξ ( b , n ) )}^{p} {\sum }_{i} {T}_{i} ( b , n )$$

In some embodiments a LFE inverse filterbank 1711 is configured to receive the output of the LFE determiner and is configured to convert the signal to the time domain to form time domain LFE signals 1712 which are also passed to an ambisonics to multichannel converter 1713.

The ambisonics to multichannel converter 1713 is configured to convert the ambisonic signals to multi-channel signals. Furthermore as these signals are missing the LFE signals the ambisonics to multichannel converter is configured to merge the received LFE signals with the multichannel signals (without the LFE). The resulting multichannel signals 1714 therefore contain also the LFE signals.

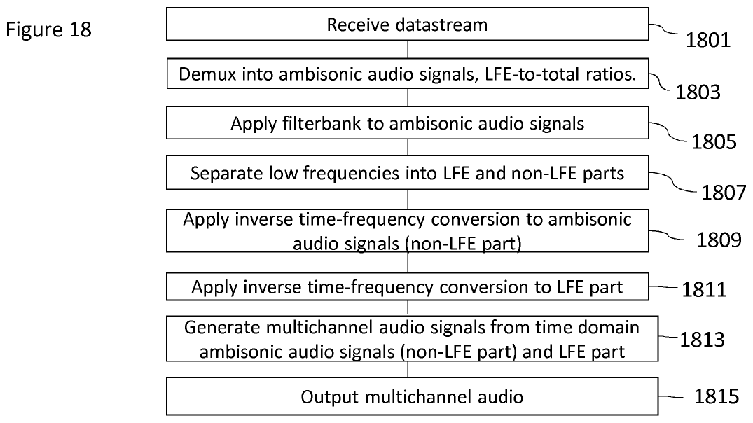

With respect to FIG. 18 is shown a summary of the operation of the synthesis processor shown in FIG. 17.

The first operation is one of receiving the datastream as shown in FIG. 18 by step 1801.

The datastream may then be demultiplexed into ambisonic audio signals and metadata such as LFE-to-total ratios as shown in FIG. 18 by step 1803.

The ambisonic audio signals may be filtered into frequency bands as shown in FIG. 18 by step 1805.

The low frequencies generated by the filterbank may then be separated into LFE and non-LFE parts as shown in FIG. 18 by step 1807.

The ambisonic audio signals including the non-LFE parts of the low frequencies may then be inverse time-frequency domain converted as shown in FIG. 18 by step 1809.

The LFE parts are then inverse time-frequency domain transformed to generate the LFE time domain audio signals as shown in FIG. 18 by step 1811.

The multichannel audio signals may then be generated based on a combination of the LFE time domain audio signals and time domain ambisonic audio signals as shown in FIG. 18 by step 1813.

The multichannel audio signals may then be output as shown in FIG. 18 by step 1815.

In the example above the output is reproduced as a multichannel (loudspeaker) audio signals. However in a manner similar to above the same data stream can also be reproduced binaurally. In this case, the LFE-to-total energy ratios can be simply omitted, and an ambisonics to binaural conversion is applied directly on the received ambisonic signals.

In some further embodiments the synthesis processor may be configured to synthesize the LFE-to-total energy ratios from parametric audio stream where metadata does not include LFE-to-total energy ratios. In these embodiments the LFE-to-total energy ratios can be estimated in manner similar to that shown in FIG. 11 with a difference in that the total energies are computed from the transport audio signals instead of the microphone-array signals. Once LFE-to-total energy ratios are calculated, they are combined with the existing metadata to produce the transcoded metadata (than includes also the LFE-to-total energy ratios). Finally, transcoded metadata is combined with the audio signals to produce new parametric audio stream.

In most cases, there is no need to process the audio signals and therefore prevent the need to transcode the audio signals.

In such a manner the embodiments described herein enable transmitting the LFE information in the case of spatial audio with sound-field related parameterization. Therefore these embodiments enable a reproduction system which can reproduce audio with the LFE speaker (typically a subwoofer) and furthermore enables a dynamically determined portion of the low-frequency energy to be reproduced with the LFE speaker, which allows the artistic vision of the audio engineer to be reproduced. In other words the embodiments described herein enable the ‘right’ amount of low-frequency energy to be reproduced using the LFE speaker, thus preserving the artistic vision.

Furthermore, the embodiments enable transmitting the LFE information in the case of spatial audio transmitted as Ambisonic signals.

Moreover, the embodiments propose methods for synthesizing the LFE channel in the case of microphone-array and/or Ambisonic input.

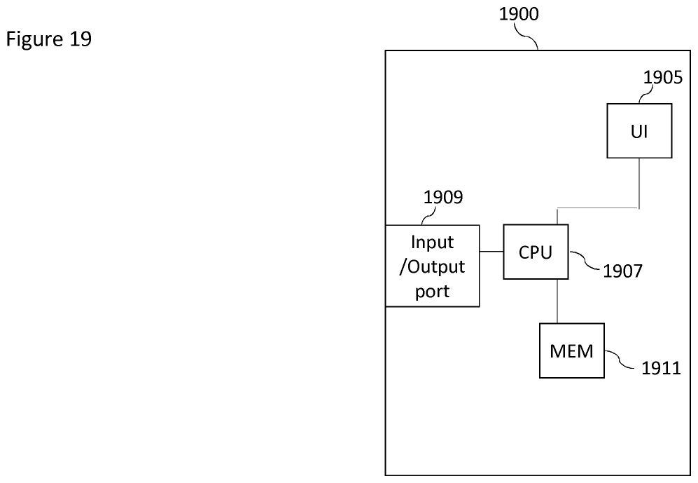

With respect to FIG. 19 an example electronic device which may be used as the analysis or synthesis device is shown. The device may be any suitable electronics device or apparatus. For example in some embodiments the device 1400 is a mobile device, user equipment, tablet computer, computer, audio playback apparatus, etc.

In some embodiments the device 1900 comprises at least one processor or central processing unit 1907. The processor 1907 can be configured to execute various program codes such as the methods such as described herein.

In some embodiments the device 1900 comprises a memory 1911. In some embodiments the at least one processor 1907 is coupled to the memory 1911. The memory 1911 can be any suitable storage means. In some embodiments the memory 1911 comprises a program code section for storing program codes implementable upon the processor 1907. Furthermore in some embodiments the memory 1911 can further comprise a stored data section for storing data, for example data that has been processed or to be processed in accordance with the embodiments as described herein. The implemented program code stored within the program code section and the data stored within the stored data section can be retrieved by the processor 1907 whenever needed via the memory-processor coupling.

In some embodiments the device 1900 comprises a user interface 1905. The user interface 1905 can be coupled in some embodiments to the processor 1907. In some embodiments the processor 1907 can control the operation of the user interface 1905 and receive inputs from the user interface 1905. In some embodiments the user interface 1905 can enable a user to input commands to the device 1900, for example via a keypad. In some embodiments the user interface 1905 can enable the user to obtain information from the device 1900. For example the user interface 1905 may comprise a display configured to display information from the device 1900 to the user. The user interface 1905 can in some embodiments comprise a touch screen or touch interface capable of both enabling information to be entered to the device 1900 and further displaying information to the user of the device 1900.

In some embodiments the device 1900 comprises an input/output port 1909. The input/output port 1909 in some embodiments comprises a transceiver. The transceiver in such embodiments can be coupled to the processor 1907 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1909 may be configured to receive the loudspeaker signals and in some embodiments determine the parameters as described herein by using the processor 1907 executing suitable code. Furthermore the device may generate a suitable transport signal and parameter output to be transmitted to the synthesis device.

In some embodiments the device 1900 may be employed as at least part of the synthesis device. As such the input/output port 1909 may be configured to receive the transport signals and in some embodiments the parameters determined at the capture device or processing device as described herein, and generate a suitable audio signal format output by using the processor 1907 executing suitable code. The input/output port 1909 may be coupled to any suitable audio output for example to a multichannel speaker system and/or headphones or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising:
at least one processor; and
at least one non-transitory memory including computer program code, the at least one memory and the computer program code configured to, with the at least one processor, cause the apparatus to:
receive at least two audio signals;
determine at least one lower frequency effect information based on the at least two audio signals;
determine at least one transport audio signal based on the at least two audio signals; and
control a transmission/storage of the at least one transport audio signal and the at least one lower frequency effect information such that a rendering based on the at least one transport audio signal and the at least one lower frequency effect information enables a determination of at least one low frequency effect channel.

2. The apparatus as claimed in claim 1, wherein the at least one memory and the computer program code are configured to, with the at least one processor, cause the apparatus to:
determine at least one spatial metadata parameter based on the at least two audio signals, and wherein the apparatus is caused to control the transmission/storage of the at least one transport audio signal and the at least one lower frequency effect information is further caused to control a transmission/storage of the at least one spatial metadata parameter.

3. The apparatus as claimed in claim 2, wherein the at least one spatial metadata parameter comprises at least one of:
at least one direction parameter associated with at least one frequency band of the at least two audio signals; or
at least one direct-to-total energy ratio associated with the at least one frequency band of the at least two audio signals.

4. The apparatus as claimed in claim 1, wherein the at least one memory and the computer program code are configured to, with the at least one processor, cause the apparatus to determine the at least one transport audio signal based on the at least two audio signals is based on determining at least one of:
a downmix of the at least two audio signals;
a selection of the at least two audio signals;
an audio processing of the at least two audio signals; or
an ambisonic audio processing of the at least two audio signals.

5. The apparatus as claimed in claim 1, wherein the at least two audio signals are at least one of:
multichannel loudspeaker audio signals;
ambisonic audio signals; or
microphone array audio signals.

6. The apparatus as claimed in claim 5, wherein the at least two audio signals are multichannel loudspeaker audio signals, and wherein the at least one memory and the computer program code are configured to, with the at least one processor, cause the apparatus to determine the at least one lower frequency effect information based on the at least two audio signals is based on determining at least one low frequency effect to total energy ratio is further based on a computation of at least one ratio between energy of at least one defined low frequency effect channel of the multichannel loudspeaker audio signals and a selected frequency range of all channels of the multichannel loudspeaker audio signals.

7. The apparatus as claimed in claim 5, wherein the at least two audio signals are microphone array audio signals or ambisonic audio signals and wherein the at least one memory and the computer program code are configured to, with the at least one processor, cause the apparatus to determine the at least one lower frequency effect information based on the at least two audio signals based on at least one of:
determining at least one low frequency effect to total energy ratio based on a time filtered direct-to-total energy ratio value; or
determining at least one low frequency effect to total energy ratio based on an energy weighted time filtered direct-to-total energy ratio value.

8. The apparatus as claimed in claim 1, wherein the at least one memory and the computer program code are configured to, with the at least one processor, cause the apparatus to determine the at least one lower frequency effect information based on the at least two audio signals based on determining at least one lower frequency effect information based on the at least one transport audio signal.

9. The apparatus as claimed in claim 1, wherein the lower frequency effect information comprises at least one of:
at least one low frequency effect channel energy ratio;
at least one low frequency effect channel energy; or
at least one low frequency effect to total energy ratio.

10. An apparatus comprising:
at least one processor; and
at least one non-transitory memory including computer program code, the at least one memory and the computer program code configured to, with the at least one processor, cause the apparatus to:
receive at least one transport audio signal and at least one lower frequency effect information; and
render at least one low frequency effect channel based on the at least one transport audio signal and the at least one lower frequency effect information.

11. The apparatus as claimed in claim 10, wherein the at least one memory and the computer program code are configured to, with the at least one processor, cause the apparatus to render the at least one low frequency effect channel based on the at least one transport audio signal and at least one lower frequency effect information based on:
generating at least one low frequency effect part based on a filtered part of the at least one transport audio signal and the at least one lower frequency effect information; and
generating the least one low frequency effect channel based on the at least one low frequency effect part.

12. The apparatus as claimed in claim 11, wherein the at least one memory and the computer program code are configured to, with the at least one processor, cause the apparatus to generate the filtered part of the at least one transport audio signal based on applying a filterbank to the at least one transport audio signal.

13. The apparatus as claimed in claim 10, wherein the at least one memory and the computer program code are configured to, with the at least one processor, cause the apparatus to:
receive at least one at least one spatial metadata parameter; and
generate at least two audio signals based on the at least one transport audio signal and the at least one spatial metadata parameter.

14. The apparatus as claimed in claim 10, wherein the lower frequency effect information comprises at least one of:
at least one low frequency effect channel energy ratio;
at least one low frequency effect channel energy; or
at least one low frequency effect to total energy ratio.

15. A method comprising:
receiving at least two audio signals;
determining at least one lower frequency effect information based on the at least two audio signals;
determining at least one transport audio signal based on the at least two audio signals; and
controlling a transmission/storage of the at least one transport audio signal and the at least one lower frequency effect information such that a rendering based on the at least one transport audio signal and the at least one lower frequency effect information enables a determination of at least one low frequency effect channel.

16. A method comprising:
receiving at least one transport audio signal and at least one lower frequency effect information; and
rendering at least one low frequency effect channel based on the at least one transport audio signal and the at least one lower frequency effect information.

17. The method as claimed in claim 16, wherein the rendering comprises:
generating at least one low frequency effect part based on a filtered part of the at least one transport audio signal and the at least one lower frequency effect information; and
generating the least one low frequency effect channel based on the at least one low frequency effect part.

18. The method as claimed in claim 17, wherein the generating comprises applying a filterbank to the at least one transport audio signal.

19. The method as claimed in claim 17, wherein the method further comprises:
receiving at least one at least one spatial metadata parameter; and
generating at least two audio signals based on the at least one transport audio signal and the at least one spatial metadata parameter.

20. The method as claimed in claim 17, wherein the lower frequency effect information comprises at least one of:
at least one low frequency effect channel energy ratio;
at least one low frequency effect channel energy; or
at least one low frequency effect to total energy ratio.
